(19) United States
(12) Patent Application Publication
(10) Pub. No.: US 2024/0051395 A1
(43) Pub. Date: Feb. 15, 2024

(54) CURVED DISPLAY DEVICE

(71) Applicant: VALEO COMFORT AND DRIVING ASSISTANCE, Créteil (FR)

(72) Inventors: Michael Irzyk, Creteil (FR); Stephane Dalmayrac, Creteil (FR); Adrien Heim, Creteil (FR)

(73) Assignee: VALEO COMFORT AND DRIVING ASSISTANCE, Créteil (FR)

(21) Appl. No.: 18/268,020

(22) PCT Filed: Dec. 16, 2021
(86) PCT No.: PCT/EP2021/086317

§ 371 Date: Jun. 16, 2023

(30) Foreign Application Priority Data
Dec. 17, 2020 (FR) FR2013509

(51) Int. Cl. B60K 37/02

(52) U.S. Cl. CPC B60K 37/02; B60K 2370/1523; B60K 2370/688; B60K 2370/816; B60Y 2200/11

(57) ABSTRACT

The invention relates to a display device (100) comprising: —a display (150); —a curved and at least partially transparent plate (170); and —a structural part (180) comprising a frame (181) which at least partially frames the display and one end face (182) of which forms a bearing surface onto which said plate is applied. According to the invention, the bearing surface is curved according to a mathematical function which has a hyperbolic cosine term.

### TECHNICAL FIELD OF THE INVENTION

The present invention relates in a general manner to the technical field of displaying.

It relates more particularly to a display device comprising:
a display,
a curved and at least partially transparent sheet; and
a structural component comprising a frame that at least partially frames the display and of which an end face forms a bearing surface on which said sheet presses.

It is applicable in particular to display devices designed to be integrated into the dashboards of motor vehicles.

### PRIOR ART

Such display devices are used in motor vehicles for displaying information intended for the driver of the motor vehicle or for the passengers of this motor vehicle.

In this device, the display is the functional element that displays the information.

The sheet, which is made of glass for example, makes it possible to cover the display and forms a façade that gives the display device an esthetic appearance. It can be curved so as to give a more immersive impression to the individual using it.

Finally, the structural component makes it possible to fasten the assembly in the dashboard.

Adhesive is generally used to fasten the sheet to the structural component. This is advantageous in particular when the sheet has a non-zero curvature, since in this case the structural component can be shaped to keep the sheet at the desired curvature.

Once deformed and bonded to the structural component, the sheet has a constant radius of curvature. This sheet is said to have a cylindrical shape with a large radius of curvature.

The major drawback of such a display device is that in use, the sheet may become partially detached from the structural component, by delamination.

### PRESENTATION OF THE INVENTION

In order to remedy the aforementioned drawback of the prior art, the present invention proposes working not on the adhesive used to bond the sheet to the structural component, but rather on the shape of this sheet and of this structural component.

More particularly, what is proposed according to the invention is a display device as defined in the introduction, in which the bearing surface is curved substantially according to a mathematical function that has a hyperbolic cosine term.

The applicant has observed that, in the prior art, the cylindrical shape of the sheet is such that the adhesion forces that the adhesive exerts are not uniform over the entire bonding surface. In practice, when the sheet has the shape of a rectangle that is horizontally elongate and curved around a vertical axis, these stresses are greater in the central part than on the sides. There is then a risk of delamination of the central part of the sheet with respect to the structural component.

The idea of the invention is therefore to design the sheet and the structural component in such a way that the adhesion forces that the adhesive exerts are more uniform, so that the risks of delamination of the sheet with respect to the structural component are very limited as long as the display device is used under normal use conditions.

The hyperbolic cosine shape was found to be the most natural shape, which provides the best distribution of the loads. This is why it is used in this case.

It should be noted that the display will generally be bonded to the sheet. The advantages set out above will then also apply to the bonding of this display to the sheet.

Other advantageous and non-limiting features of the display device in accordance with the invention, taken individually or according to all technically possible combinations, are the following:
there is a section plane of the structural component in which the line of said bearing surface is a curve;
there is an orthonormal reference system that is situated in the section plane and in which the mathematical function of the curve is expressed by the following equation: y(x)=b·cosh(x/a)+c, with y the value of the ordinate, x the value of the abscissa, a, b and c predetermined constants;
there is at least one other section plane of the structural component in which the line of said bearing surface is rectilinear;
the display presses on the sheet;
the display is bonded to the sheet;
the sheet is bonded to the end face of the frame;
the frame has four branches, including two opposite first branches of lengths greater than the other two branches, the average width of the two first branches being at least two times smaller than the average width of the other two branches;
the sheet has a constant thickness;
the sheet is made of glass;
the bearing surface is discontinuous and delimits at least one cutout that forms a passage for an electrical cable or for a means for fastening a cover;
there is provided an illumination unit mounted on the structural component, at the rear of the display.

Of course, the various features, variants and embodiments of the invention can be combined with one another in various combinations, as long as they are not mutually incompatible or mutually exclusive.

### DETAILED DESCRIPTION OF THE INVENTION

The following description with reference to the appended drawings, which are given by way of non-limiting examples, will give a good understanding of what constitutes the invention and how it can be implemented.

In the appended drawings:

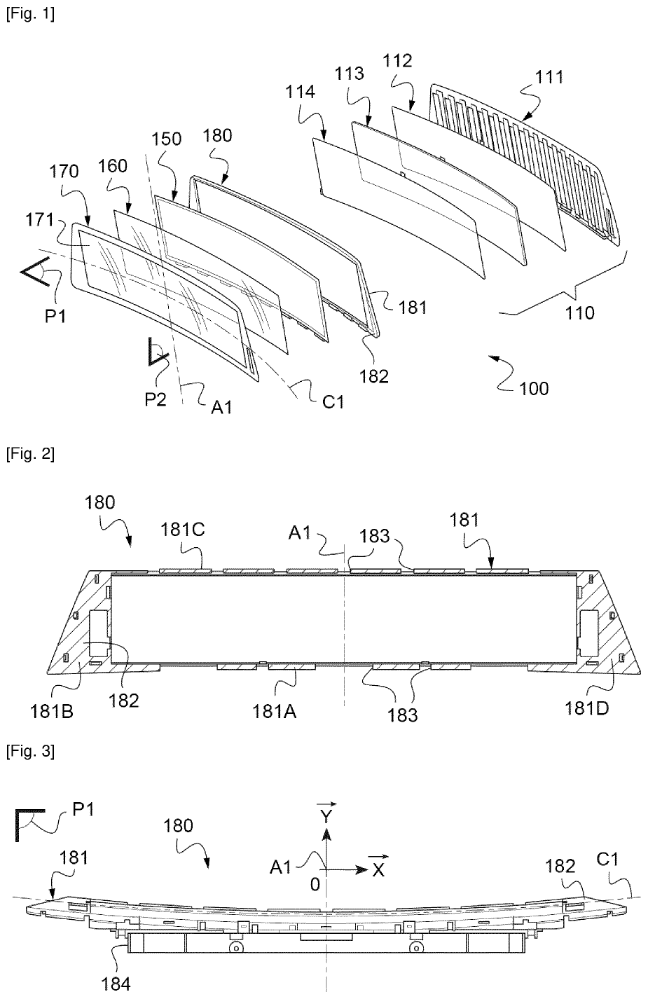

FIG. 1 is an exploded schematic perspective view of a display device in accordance with the invention;

FIG. 2 is a front view of a structural component of the display device in FIG. 1;

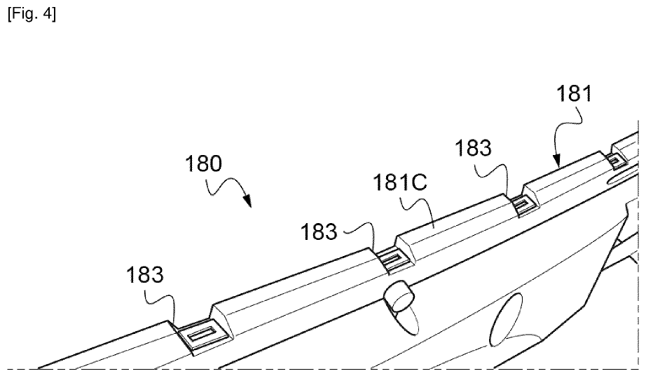

FIG. 3 is a bottom view of the structural component in FIG. 2;

FIG. 4 is a schematic perspective view of a detail of the structural component in FIG. 2.

FIG. 1 shows a display device 100.

This display device 100 is specially designed to be used in a motor vehicle passenger compartment, for example in a car, van or truck passenger compartment.

It is more specifically provided to be fastened in the dashboard of this motor vehicle.

It is designed to be integrated into this dashboard, such that all of its components are housed therein and such that its façade extends in the continuation of the front face of the dashboard.

At this stage, certain terms that will be used in the following description can be defined.

The terms “front” and “rear” will be used with respect to the passenger compartment of the motor vehicle, the front of an element denoting the side of this element that is turned toward the user of the display device (therefore toward the trunk of the vehicle) and the rear denoting the side of this element that is turned away (therefore toward the hood of the vehicle).

The terms “lower” and “upper” will be used with respect to this motor vehicle, the lower side of an element denoting the part of this element that is turned toward the floor of the vehicle and the upper side denoting the part of this element that is turned toward the ceiling.

For clarity of the disclosure, it will be considered in the rest of the description that the display device will be installed in the dashboard in such a way that its façade extends generally in a vertical plane (i.e. it extends generally in length along a horizontal axis and in width along a vertical axis). Of course, in practice, the display device can be installed in the dashboard of the vehicle in some other way.

The display device 100 comprises at least three elements, namely a display 150, a façade sheet 170 provided in particular to protect the display 150, and a structural component 180 allowing these two elements to be fastened in the dashboard of the vehicle.

In this case, it has more elements. Thus, it also has an illumination unit 110 that makes it possible to backlight the display 150 and a protective cover (not shown).

In the first part of this disclosure, it is possible to briefly describe all of these components with reference to FIG. 1.

In this case, the display 150 is a light modulator.

It is for example a TFT LCD (“Thin-Film Transistor Liquid Crystal Display”) tile. This tile has the shape of a sheet of constant thickness and rectangular outline.

Conventionally, it comprises a polarizer and a matrix of liquid crystal cells that each controllably affect the polarization of the incident light (produced by the illumination unit 110). Thus, the presence of the polarizer makes it possible to obtain at output a quantity of light that is dependent on the polarization imparted by the relevant cell and that is therefore adjustable by controlling this cell.

The illumination unit 110 has a light source (not visible, formed for example of several tens of light-emitting diodes) and, at the front of the latter, three films 112, 113, 114 that make it possible to even out the light over the entire surface of the rear face of the display 150.

The illumination unit 110 also has an opaque rear wall 111 to which the light source and the three films are fastened, and which is itself fastened to the structural component 180.

Of course, this configuration is specific to the use of a display of the TFT-LCD type. By way of example, if the display is of the OLED type, no illumination unit separate from the display is used.

In this case, and preferentially, the display 150 is bonded by its front face to the façade sheet 170.

A film of adhesive 160 is used for this purpose to bond the entire surface of the front face of the display 150 to the rear face of the façade sheet 170.

The adhesive used is in this case an optical adhesive. The positioned adhesive film 160 has a thickness of between 0.1 and 1 mm (in this case equal to 0.5 mm).

A central part 171 of the façade sheet 170 therefore presses against the display 150 via the adhesive film 160.

According to one possible embodiment, a matrix of detectors (for example capacitive detectors) may be interposed between the display 150 and the façade sheet 170, in order to form a touch-sensitive display device. As a variant, this matrix of detectors could be integrated into the display 150.

The façade sheet 170 is curved and at least partially transparent. It is curved around an axis A1 situated at the front of this sheet, such that its front face is concave.

It has a constant thickness that is preferentially between 0.5 and 2 mm, in this case equal to 1.1 mm.

In the example described, the façade sheet 170 covers the entire front face of the display device 100. It thus extends beyond each side of the display 150.

The façade sheet 170 is for example made of glass. However, as a variant, the façade sheet 170 could be made of polymer material, for example poly(methyl methacrylate) or polycarbonate or a combination of these two materials.

In the embodiment described here, the façade sheet 170 is curved.

In a first embodiment, this curvature is obtained at the moment when the façade sheet 170 is bonded to the structural component 108. Before that, it is flat.

In a second embodiment, it is shaped (for example by molding) with the curvature that it will have once the display device has been assembled, or manufactured so as to be flat and then forcibly curved during a shaping step (a process of heating and deformation by gravity can for example be used).

Whatever the case, the façade sheet 170 is bonded to the structural component 180. It is more specifically bonded via its rear face (in a peripheral zone situated around the central zone 171) to the front end face 182 of the structural component 180.

This structural component 180 is shown in detail in FIGS. 2 and 3.

It comprises a rear part (hereinafter called base 184) and a front part (hereinafter called frame 181) extending in the direction of the façade sheet 170, from the base 184.

The base 184 has four lateral walls disposed in a rectangle around the display 150. It is thus open toward the front and the rear.

The rear wall 111 of the illumination unit 110 is provided to be fastened against the rear end edge of the base 184 so as to close it.

The frame 181 extends from the front edge of the base 184, like a collar that surrounds the whole of this base 184.

It has four branches 181A, 181B, 181C, 181D (see FIG. 2).

Its upper branch 181C and lower branch 181A are thinner than its two lateral branches 181B, 181D. In practice, they have constant widths (with the exception of the zones in which they are interrupted), of the order of 3 to 10 mm, and more preferentially between 5 and 10 mm.

The lateral branches 181B, 181D for their part are in the shapes of rectangular trapeziums, the two parallel edges of which extend in the continuation of the outer edges of the upper branch 181C and lower branch 181A. These lateral branches 181B, 181D therefore form flanges via which the display device 100 can be fastened in the dashboard of the motor vehicle.

The structural component 180 thus frames the display 150 and the illumination unit 110.

It is, for example, made of metal (in this case magnesium or a magnesium-based alloy, or alternatively of aluminum or an aluminum-based alloy). It can thus in particular contribute to dissipating the heat produced by the illumination unit 110.

The front end face 182 of the frame 181 is provided to receive the façade sheet 170.

It is therefore curved such that the façade sheet 170 can press on it while having the desired curvature. It will then be considered that the rear face of the façade sheet 170 and the front end face 182 of the frame 181 have the same curvature.

The objective is that this curvature ensures good distribution of the stresses in the adhesive used to fasten the façade sheet 170 to the frame 181. This objective is more important the smaller the bonding surface, in particular at the upper branch 181C and lower branch 181A of the frame 181.

According to a particularly advantageous feature of the invention, the front end face 182 of the frame 181 is then curved according to a shape that is substantially defined by a mathematical function having a hyperbolic cosine term.

“Substantially” is understood to mean that the front end face 182 of the frame 181 is curved according to this mathematical function, to within the manufacturing tolerances. In this case, the dispersion between the required shape (given the mathematical function) and the obtained shape of the front end face 182 of the frame 181 is preferably less than 1 mm at any point. In other words, the minimum Euclidean distance between these two geometric surfaces is less than one millimeter at any point.

In this case, the front end face 182 is said to be defined by a mathematical function in the sense that there is at least one plane in which the intersection (hereafter called “line”) of the front end face 182 with this plane forms a curve C1 (see FIG. 3) of which the mathematical function has a hyperbolic cosine term.

The front end face 182 of the frame 181 is in this case curved symmetrically on either side of a plane that, in this example, extends vertically.

In this case, regardless of the horizontal section plane P1 under consideration, the line of the front end face 182 of the frame 181 extends along a curve C1 of which the mathematical function has a hyperbolic cosine term.

The front end face 182 of the frame 181 is preferentially profiled in the sense that its line extends along a curve of which the mathematical function is the same regardless of the horizontal section plane P1 under consideration.

By contrast, regardless of the vertical section plane P2 under consideration, the line of the front end face 182 of the frame 181 extends along a straight line.

In the rest of this disclosure, consideration will be given more particularly to a horizontal section plane P1, namely the one that passes through the middle of the frame 181 (see FIG. 3). In this section plane P1, consideration can be given to the orthonormal reference system (0, X, Y) of which the origin 0 is situated in the plane of symmetry of the front end face 182 of the frame 181, on an imaginary axis A1 around which the front end face 182 is curved. In this reference system, the Y axis is situated toward the front and the X axis is oriented toward the side of the vehicle.

The line under consideration then forms a curve C1 of which the mathematical function expressed in this orthonormal reference system (0, X, Y) has the following equation:

y(x)=b·cosh(x/a)+c [Math. 1]

In this equation, the term y corresponds to the value of the ordinate, the term x corresponds to the value of the abscissa, a, b and c are predetermined constants.

The constant c has a value that depends on the position of the origin O of the chosen reference system.

The constants a and b are for their part chosen according to the desired shape of the curve C1.

By way of illustrative example, if the façade sheet extends in width over 300 mm and its radius of curvature is such that the deflection of this sheet is 10 mm, the constants a and b will respectively take the values 110 and 10. Of course, this is just one example among so many others.

By virtue of this hyperbolic cosine shape, the loads that are exerted in the adhesive are well distributed over the entire front end face 182 of the frame 181. The façade sheet 170 is then able to withstand significant tensile and torsional loads, greater than 400 N, while this sheet is particularly thin and the bonding zones are not very wide.

In this case, the bearing surface formed by the front end face 182 of the frame 181 for the façade sheet 170 extends along an outline of rectangular shape.

As shown in FIG. 2, this bearing surface is however discontinuous and delimits at least one cutout 183 that forms a passage, for example for an electrical cable or for a means for fastening the protective cover.

More specifically in this case, a plurality of cutouts 183 are provided in the upper branch 181C and lower branch 181A of the frame 181.

The cutouts 183 provided in the lower branch 181A of the frame 181 in particular allow the passage of electrical cables so as to electrically connect the display 150 and the illumination unit 110 to electrical power supply and/or control circuits (not shown).

In this case, as is clearly shown in FIG. 4, the upper branch 181C of the frame 181 has a plurality of cutouts 183 that extend inward in its upper face. The bottom of each of these cutouts 183 accommodates fastening means (in this case clip-fastening means) allowing the protective cover (not shown) to be fastened thereto.

At this stage, it is possible to describe in greater detail how the display device 100 is designed and then assembled.

The research unit in charge of the design of the vehicle determines a desired radius of curvature for the façade sheet 170 and a desired width for the display 150.

As has been set out above, the façade sheet 170, which is provided to be bonded to the structural component 180, is intended to be curved not in an arc of a circle but in an arc of a hyperbolic cosine curve.

As such, the desired radius of curvature is only one order of magnitude of the desired curvature.

This radius of curvature can be very small since the distance between the user and the screen is particularly small in a vehicle, so that the desired immersion effect is obtained by greatly curving the façade sheet 170. This radius of curvature is for example between 20 cm and 5 m.

The design of the display device 100 will then consist in choosing the values of the constants a and b in the aforementioned equation Math. 1.

This choice will be made such that the display 150 has the desired width and such that the distance between an arc of a circle having the desired radius of curvature and the curve C1 of the front end face 182 of the frame 181 is minimal. This search for a minimum will preferably be carried out by minimizing the root mean square (RMS) between these two curves.

Once designed, the display device 100 can be assembled.

In the first embodiment, the device is assembled by taking a flat façade sheet and bonding it to the front end face 182 of the frame 181 (and this forces it to curve in the desired way). The display 180 is then bonded to the rear of this façade sheet 170.

In the second embodiment, the façade sheet 170 is manufactured so as to be curved even before it is installed on the frame 181. It is then bonded to the frame 181 before the display 150 is itself bonded to its rear face.

The present invention is in no way limited to the embodiments described and shown, but those skilled in the art will know how to add any variant in accordance with the invention thereto.

Thus, the façade sheet could have a shape other than a trapezoidal shape, for example a rectangular shape. It could have a variable thickness.

The structural component could for its part have a different shape. Its frame could for example have branches of different shapes, with or without cutouts.

1. A display device comprising:
a display;
a curved and at least partially transparent sheet; and
a structural component comprising a frame that at least partially frames the display and of which an end face forms a bearing surface on which said sheet presses,
wherein the bearing surface is curved substantially according to a mathematical function that has a hyperbolic cosine term.

2. The display device as claimed in claim 1, wherein:
there is a section plane of the structural component in which the line of said bearing surface is a curve, and
there is an orthonormal reference system situated in the section plane in which the mathematical function of the curve is expressed by the following equation:
y(x)=b·cosh(x/a)+c, with:
y the value of the ordinate,
x the value of the abscissa,
a, b and c predetermined constants.

3. The display device as claimed in claim 1, wherein there is at least one other section plane (P2) of the structural component (180) in which the line of said bearing surface is rectilinear.

4. The display device as claimed in claim 1, wherein the display presses on the sheet and is bonded to the sheet.

5. The display device as claimed in claim 1, wherein the sheet is bonded to the end face of the frame.

6. The display device as claimed in claim 1, wherein the frame has four branches, including two opposite first branches of lengths greater than the other two branches, the average width of the two first branches being at least two times smaller than the average width of the other two branches.

7. The display device as claimed in claim 1, wherein the sheet has a constant thickness.

8. The display device as claimed in claim 1, wherein the sheet is made of glass.

9. The display device as claimed in claim 1, wherein the bearing surface is discontinuous and delimits at least one cutout that forms a passage for an electrical cable or for a means for fastening a cover.

10. The display device as claimed in claim 1, wherein there is provided an illumination unit mounted on the structural component, at the rear of the display.
